(19) United States
(12) Patent Application Publication
(10) Pub. No.: US 2004/0020534 A1
(43) Pub. Date: Feb. 5, 2004

(54) Controlled pneumatic valve

(76) Inventor: Henri Beau, Saint Polgues (FR)

Correspondence Address: PARKHURST & WENDEL, L.L.P., 1421 PRINCE STREET, SUITE 210, ALEXANDRIA, VA, 22314-2805, US

(21) Appl. No.: 10/466,421

(22) PCT Filed: Feb. 15, 2002
(86) PCT No.: PCT/FR02/00596

(51) Int. Cl. B60C 23/10; F16K 15/20

(52) U.S. Cl. 137/223; 152/416

(57) ABSTRACT

The invention relates to a controlled pneumatic valve intended for the remote control of the inflation and deflation of a volume, comprising a membrane held between a half-body and a grooved ring. The membrane delimits a pilot chamber with the half-body and an exhaust chamber with the grooved ring. Said exhaust chamber communicating firstly with a bore opening out into the volume and secondly with the pilot chamber by means of a non-return valve housed in a body. The pilot chamber is connected to a high-low pressure circuit via an intake piece. Said non-return valve pushes the membrane in order to close the bore. The pneumatic valve comprises a mechanical means which is controlled by the membrane and which is used to open the non-return valve, in addition to the action of the pressure, at low pressure. Said means comprises a bridge that is fixed to the membrane and a finger which is disposed opposite the non-return valve. The invention is suitable for low-pressure tire control.

### BACKGROUND OF THE INVENTION

1. Field of the Invention

The technical scope of the present invention is that of remote controlled devices to inflate and deflate a volume using a pressurized gaseous fluid and relates more particularly to the remote control of the internal pressure of the pneumatic tire of an automobile vehicle wheel.

2. Description of Related Art

In the preferred domain of application above, we know that it is sometimes useful to be able to remotely control the pneumatic tire pressure of a vehicle so as to be able to adapt its bearing capacity according to the state of the ground over which the vehicle is traveling. This is, in particular, the case for all-purpose vehicles which must be able to move efficiently over ever-changing types of ground, such as hard, stony or soft ground. This adaptation needs to be able to be carried out without the driver being obliged to halt the vehicle so as to manually carry out an adjustment or control of the internal pressure of the vehicle's pneumatic tires.

Thus, patent EP-0 296 017 discloses a pneumatic valve comprising a membrane linked to a servo stop valve and held between a half-body and a grooved ring delimiting a pilot chamber with the half-body and an exhaust chamber with the grooved ring, said exhaust chamber communicating with a bore opening out into the volume, the pilot chamber being subjected to a high-low pressure circuit via an intake piece, said servo valve pushing the membrane to close the bore and co-axially incorporating a non-return valve. Such a valve is satisfactory but suffers from a certain number of drawbacks.

In fact, this type of valve is difficult to implement in agricultural-type vehicles whose pneumatic tires must be able to operate at relatively low pressures. By low pressure, we mean pressure lower than 10⁵ Pa. This results from the absence of sealing in the anti-return valve, the forces dependant on the low pressure retained in the volume are not sufficient to ensure perfect contact between a ball and the non-return valve seat.

Moreover, in the event that the valve is mounted in an off-center position on the wheel, the centrifugal force acts on the non-return valve ball and disturbs its closing thereby causing the gradual deflation of the pneumatic tire.

Additionally, repeated use of this valve reveals a weakening of the membrane.

The aim of the present invention is thus to overcome the previously mentioned drawbacks whilst providing a totally reliable device which may be used over a large pressure range.

### SUMMARY OF THE INVENTION

The invention thus relates to a controlled pneumatic valve intended for the remote control of the inflation and deflation of a volume, comprising a membrane held between a half-body and a grooved ring delimiting a pilot chamber with the half-body and an exhaust chamber with the groove ring, said exhaust chamber communicating firstly with a bore opening out in the volume and secondly with the pilot chamber by means of a non-return valve housed in a body, the pilot chamber being connected to a high-low pressure circuit via an intake piece, said servo valve pushing the membrane to close the bore, wherein it comprises mechanical means ensuring the opening of the non-return valve in addition to the action of the pressure in order to open said valve at low pressure.

According to one characteristic, the valve comprises elastic means to retain the non-return valve in its closed position.

According to another characteristic, the elastic retention element is of the spring type, one end of which presses on the non-return valve and the other on the body.

According to yet another characteristic, the mechanical control means comprise an opening system for the non-return valve controlled by the membrane.

Advantageously, the opening system is constituted by a bridge fastened to the membrane and a finger placed opposite the valve.

Advantageously, the non-return valve is of the ball or truncated cone piston type.

According to yet another characteristic, the linking surface between the bridge and the membrane ensures a limitation on the deformation of said membrane.

According to yet another characteristic, the mechanical means ensure the valve is centered.

The invention also relates to the installation of the remote control of the inflation and deflation of a volume that comprises piping connecting the intake piece of the pilot chamber to two connections leading, respectively, to a high-low pressure source, a selective control distributor placed on each connection and a manometer (M) placed on the line between the valve and the distributors, comprising a controlled pneumatic valve as described previously.

One advantage of the valve according to the invention lies in the absolute control of low pressure sealing whilst preserving the advantages proffered by the valve in the aforementioned patent, that is to say compactness and reduced cost.

A further advantage lies in the extended useful life of the valve according to the invention.

Yet another advantage lies in the possibility of balancing the pressures between two tires during the measurement phases. This possibility is advantageous in the case where the axles are dealt with separately.

### BRIEF DESCRIPTION OF THE DRAWINGS

Other characteristics, particular and advantages of the invention will become more apparent from reading the following additional description, given by way of illustration and in reference to the appended drawings, in which:

FIG. 1 is a schematic view showing one example of the installation of the subject of the invention,

FIG. 2 is a cross section showing the valve according to the invention in a first embodiment of the non-return valve,

FIG. 3 is a partial view of a second embodiment of the non-return valve of the valve according to the invention.

### DETAILED DESCRIPTION OF PREFERRED EMBODIMENTS

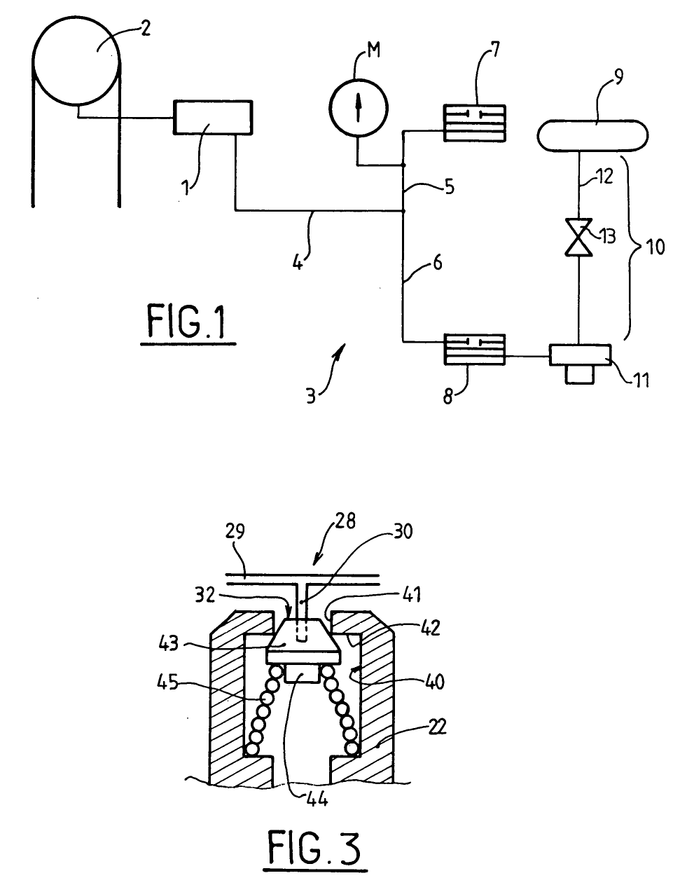

A pneumatic valve according to the invention is shown in FIG. 1, reference 1, applied to the pressure control of a pneumatic tire 2 partially shown and mounted on the wheel of an automobile vehicle (not shown). The valve 1 is connected to a high-low pressure circuit 3 by any means, such as, for example, a revolving joint structure integrated in the shaft of the wheel described by patent EP-0 296 017. The piloting installation 3 comprises piping 4 through which a fluid circulates and which is separated into two connections 5 and 6 each linked to a distributor 7 and 8 that is advantageously selectively controlled.

The distributors 7 and 8 are respectively connected to a pressurized fluid distribution source 9 or to a pressure-reducing source 10. By way of illustration, the pressure source 9 may be a compressed air accumulator or a compressor while the pressure-reducing source 10 is, for example, a liquid jet vacuum pump 11 able to be supplied by the pressure source 9 by means of piping 12 controlled by a cock 13.

The installation described above is naturally only given by way of illustration, since more complicated circuits, able to ensure other functions, may be provided. Such an installation may also be envisaged for the remote control of each wheel of an automobile vehicle individually, in groups or else in totality.

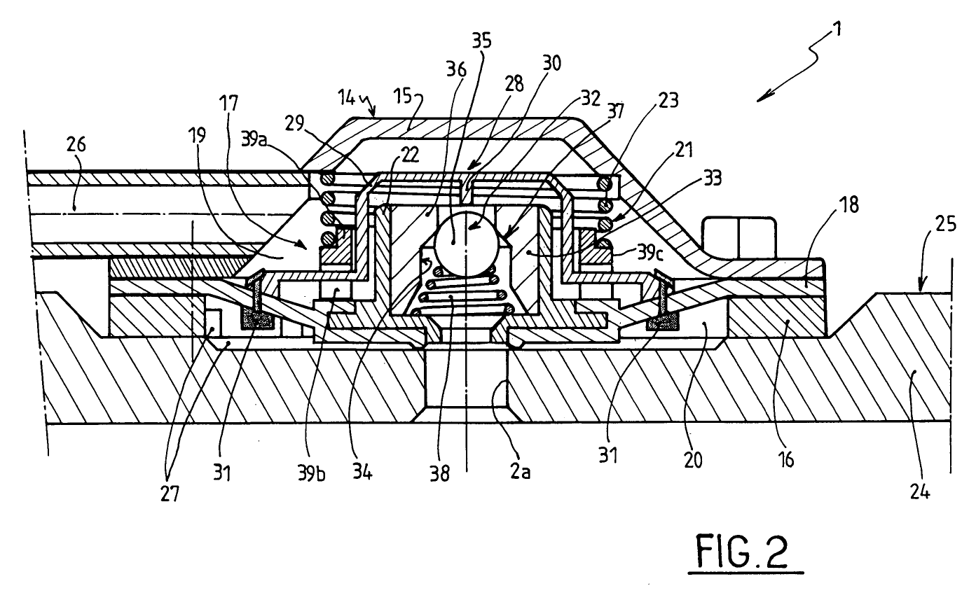

The controlled pneumatic valve 1, shown in greater detail in FIG. 2, is composed of an inflation and deflation body 14. This body 14 is divided into two parts; a half-body 15 and a grooved ring 16, made of any suitable material, assembled so as to be removable or not, face to face and machined so as to delimit a cavity 17. The half-body 15 and the grooved ring 16 are made so as to nip a deformable membrane 18 dividing the cavity 17 into two chambers, 19 and 20, respectively a pilot and an exhaust chamber. The membrane 18 is made integral, according to the invention, at its deformable part, with an opening system 28 for the valve. The latter has the overall shape of a bridge 29 onto which a pushing finger 30 has been attached. This bridge 29 is linked to the membrane 18, for example by two rivets 31, whose use to limit the deformation will be described hereafter.

A servo valve 21 assembled, for example casting into the working mould, with the membrane 18 is placed in the pilot chamber 19. This servo valve 21 is constituted by a body 22 integral with the membrane 18 and is subjected to the load of a spring 23 that surrounds the exterior of the body 22. This spring 23 presses on one side on the inner face of the half-body 15 delimiting the cavity 17 and on the other on a cap 39a encompassing the body 22. This cap is in the shape of a tubular element opening out at one end that is provided with a shoulder 39c having an external diameter greater than the diameter of the tubular element. This shoulder has two axial perforations 39b of ample and sufficient dimension to allow the opening system 28 to move. In the plane of the Figure, the spring 23 presses on the upper face of the shoulder 39c. The lower end of the cap 39a presses on a heel of the body 22.

The half-body 15 and the grooved ring 16 form a compact assembly, of reduced height and which may be integrated into the thickness of a wheel 25 rim 24. To this end, it is advantageous to produce a grooved ring 16 that will be fastened, either directly or using a seal, onto the rim 24 wall. The grooved ring 16 is associated with the half-body 14, and is preferably but not exclusively made by stamping and is associated, using any suitable means, to piping 26 linked to the pressure source. The ring 16 is said to be grooved since it has perforations 27 that allow the fluid to escape during the deflation process.

According to this embodiment, the body 22 is in the shape of a tube having a circular heel of an external diameter greater than that of the tube. The membrane 18, the body 22 and the opening system 28 thus form a unit of reduced cost that is easy to store, handle, install and remove.

A non-return valve 32 is adapted inside the body 22. To this end, but without this being essential, the body 22 is provided with an inner liner 33 having an axial bore 34 extended by a bore 36 of a lesser diameter thereby forming a tapered seat 37 at their joining point. The non-return valve has a ball 35 made to press constantly on the seat 37 by elastic retention means 38, for example a spring. This spring 38 will be tared such as to firstly ensure absolute sealing between the ball 35 and the seat 37 and secondly to offset the loads following the centrifugal accelerations.

FIG. 3 shows a partial cross section of the body 22 equipped with another embodiment of the valve. In this embodiment, the body 22 has no liner but is fitted with a first axial bore 40 extended by a second one 41 delimiting a bearing surface 42. The body 22 is fitted with a tapered valve 43 that co-operates with the bearing surface 42 so as to close off the bore 40 to prevent the tire from deflating. The valve 43 is extended by a shoulder 44 capped by a spring 45 exerting constant pressure on said valve. As in the previous embodiment, the spring 45 is placed on a collar of the body 22. The valve 43 co-operates with the finger 30 integral with the bridge 29. As previously explained, the finger 30 is intended to detach the valve 43 from the bearing surface so as to ensure the passage of air from the tire outwards thus deflating it when the membrane 18, not shown on this Figure, is activated by the spring 23.

According to a particular embodiment, the finger 30 penetrates inside a bore, shown in dotted lines, made in the valve 43. This arrangement allows the valve to be held in a centered position with respect to the bore 40.

Through the thrust exerted by the finger 30, the volume 2 and the pilot chamber are made to communicate in order to balance the pressures during measurement. In this way, we are able to measure the low pressures, below 10⁵ Pa up to a value of around 0.4.10⁵ Pa. This pressure value is particularly adapted to an application of the valve in agricultural machinery. The spring 38 reinforces the action of the pressure whilst ensuring the total sealing over the full range of acceptable pressures of the volume.

It must be noted that the limit operating pressure at low pressure is fixed by the relative dimensions of the constitutive elements of the valve. It depends on the load supplied by the return spring of the valve and the active surface as well as the efficiency of the membrane. By way of illustration, for a valve equipped with a spring supplying a load of 5 N (offsetting 1000 g for a valve of a mass of 0.5 g) and a membrane of 10 cm², the limit operating pressure is of 10⁴ Pa. Thus, if a pressure is measured that is below this limit, the result is erroneously in excess within this limit (Preal=0.03 bar and Pread=0.1 bar).

What is claimed is:

1. A controlled pneumatic valve intended for the remote control of the inflation and deflation of a volume, comprising a membrane held between a half-body and a grooved ring, said membrane delimiting a pilot chamber with said half-body and an exhaust chamber with said grooved ring, said exhaust chamber communicating firstly with a bore opening out in said volume and secondly with said pilot chamber by means of a non-return valve housed in a body, said pilot chamber being connected to a high-low pressure circuit via an intake piece, said non-return valve pushing said membrane to close said bore, wherein said controlled air valve comprises mechanical means ensuring the opening of said non-return valve in addition to the action of the pressure in order to open said non-return valve at low pressure.

2. A controlled pneumatic valve according to claim 1, wherein said valve comprises elastic means to retain said non-return valve in its closed position.

3. A controlled pneumatic valve according to claim 2, wherein said elastic retention element is of the spring type, one end of which presses on said non-return valve and the other on said body.

4. A controlled pneumatic valve according to claim 1, wherein said mechanical control means comprise an opening system for said non-return valve controlled by said membrane.

5. A controlled pneumatic valve according to claim 4, wherein said opening system is constituted by a bridge fastened to said membrane and a finger placed opposite said non-return valve.

6. A controlled pneumatic valve according to claim 5, wherein said non-return valve is of a ball or tapered piston type.

7. A controlled pneumatic valve according to claim 6, wherein the linking surface between said bridge and said membrane ensures a limitation on the deformation of said membrane.

8. A controlled pneumatic valve according to claim 7, wherein said mechanical means ensure said non-return valve is centered.

9. The installation of the remote control of the inflation and deflation of a volume that comprises piping connecting said intake piece of said pilot chamber to two connections leading, respectively, to a high-low pressure source, a selective control distributor placed on each connection and a manometer placed on the line between said non-return valve and said distributors, wherein said installation comprises a controlled pneumatic valve according to claim 1.
